(19) United States
(12) Patent Application Publication
(10) Pub. No.: US 2008/0228452 A1
(43) Pub. Date: Sep. 18, 2008

(54) Hybrid Finite Element Method for Simulating Temperature Effects on Surface Acoustic Waves

(76) Inventor: Sangpil Yoon, Campbell, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/123,343

(22) Filed: May 19, 2008

Related U.S. Application Data
(63) Continuation-in-part of application No. 11/623,260, filed on Jan. 15, 2007.

(51) Int. Cl. G06F 17/10

(52) U.S. Cl. 703/2

(57) ABSTRACT

The embodiments of the present invention provide methods and systems for simulating a SAW and/or an LSAW device, while taking into account the temperature and thickness of the substrate into consideration. The method for simulating a SAW or an LSAW device is a hybrid FE (HFE) method. The HFE simulation method uses the FE method in a region of the electrodes including a portion of the substrate and an analytic method for the remaining region of the SAW devices substrate. The surface acoustic wave is simulated by analyzing an upper portion of the waveguide including a periodic array of electrodes using a periodic finite element method by solving governing equations that take temperature effects into consideration. The simulation further involves analyzing a lower portion of the waveguide including a bottom of the waveguide with an analytic method by solving the governing equations that take temperature effects into consideration. For SAW and LSAW devices that have high operating frequencies, using the hybrid finite element method that takes temperature effects into consideration results in more accurate answers. In addition, the hybrid finite element also allows simulation of temperature effects on frequencies of SAW and LSAW devices.

### CLAIM OF PRIORITY

This application is a continuation in part of U.S. patent application Ser. No. 11/623,260, filed on Jan. 15, 2007, and entitled “A Hybrid Finite Element Method for Traveling Surface Waves with Thickness Effect,” which is incorporated herein by reference.

### BACKGROUND

The present invention relates generally to the simulating and analysis of surface acoustic wave (SAW) devices and, more particularly, to a method and a system of simulating surface acoustic wave on a simulated structure.

A Surface Acoustic Wave (SAW) is a standing or traveling acoustic wave on the surface of a substrate. A typical SAW device includes a substrate (typically made from a piezoelectric material) and a periodic array of electrodes on the surface of the substrate. Piezoelectric materials deform in response to a voltage being applied to them. Piezoelectric materials also generate a voltage in response to stress being applied to them. Leaky surface acoustic wave (LSAW) devices are also prepared by similar principles.

A SAW or an LSAW device may be simulated by numerically solving governing equations, which describe the behavior of the device. Examples of such governing equations are Newton's equation of motion and Gauss' equation of charge conservation. The material properties, geometry and driving voltages are very important to simulating the behavior of the SAW device.

One method of simulating a SAW or an LSAW device is to use the Finite Element (FE) method to solve the governing equations. The FE method involves creating a mesh, in which a problem domain is divided into a set of discrete sub-domains called elements. The governing equations, which describe the behavior of each element, are then solved for each element. The governing equations are typically solved numerically. The size of the mesh will determine the amount of computational time required to simulate the SAW device. The mesh elements should be small enough to effectively simulate the behavior of the SAW device, but not so small as to require an unreasonable amount of computational resources.

The current SAW and LSAW applications demand for broader working-temperature spectra. As dimensions of SAW and LSAW devices become smaller and operating frequencies of these devices increase, the temperature effect on the performance of SAW and LSAW devices becomes more prominent.

It is in this context that embodiments of the present invention arise.

### SUMMARY

The embodiments of the present invention provide methods and systems for simulating a SAW and/or an LSAW device, while taking into account the temperature and thickness of the substrate into consideration. The method for simulating a SAW or an LSAW device is a hybrid FE (HFE) method. The HFE simulation method uses the FE method in a region of the electrodes including a portion of the substrate and an analytic method for the remaining region of the SAW device's substrate. An aspect of the present invention is simulating a SAW in a periodic waveguide. The surface acoustic wave is simulated by analyzing an upper portion of the waveguide including a periodic array of electrodes using a periodic finite element method by solving governing equations that take temperature effects into consideration. The simulation further involves analyzing a lower portion of the waveguide including a bottom of the waveguide with an analytic method by solving the governing equations that take temperature effects into consideration. For SAW and LSAW devices that have high operating frequencies, using the hybrid finite element method that takes temperature effects into consideration results in more accurate simulations. In addition, the hybrid finite element also allows simulation of temperature effects on frequencies of SAW and LSAW devices.

It should be appreciated that the present invention can be implemented in numerous ways, including as a method, a system, or a device. Several inventive embodiments of the present invention are described below.

In one embodiment, a method for simulating a surface acoustic wave in a waveguide taking temperature effects into consideration is provided. The method includes the operation of analyzing an upper portion of the waveguide including an array of electrodes with a finite element method. The analyzing includes solving governing equations that consider temperature effects on materials of the waveguide. The method also includes the operation of analyzing a lower portion of the waveguide including a bottom of the waveguide with an analytic method. The analyzing includes solving the governing equations that consider temperature effects on materials of the waveguide.

In one embodiment, an analytic method for analyzing acoustic waves traveling through a solid state medium of a finite extant by calculating a set of eight roots of Christoffel equations taking temperature effects into consideration in a solution space representative of the solid state medium is provided. The method includes the operations of transforming the set of eight roots of the Christoffel equations that consider temperature effects on materials of the waveguide into two sets of four roots. A first set and a second set are based on the sign of the imaginary part of each root. Different temperatures yield different constants in the Christoffel equations. The first set consists of the four calculated roots of the Christoffel equations whose imaginary part is less than zero, and the second set consists of four roots of the Christoffel equations which are not in the first set. The method further includes determining the first set by calculating four non-trivial analytic solutions to the Christoffel equations whose imaginary part are less than zero, based on boundary conditions of the solution space with a bottom surface of the solution space being traction free. In addition, the method includes determining the second set of roots based on the boundary conditions and a relationship between the first set and the second set.

In yet another embodiment, a machine-readable medium having a program of instructions for simulating a surface acoustic wave in a waveguide taking temperature effects into consideration is provided. The program of instructions of the machine-readable medium includes program instructions for analyzing an upper portion of the waveguide including an array of electrodes with a finite element method. The analyzing includes solving governing equations that consider temperature effects on materials of the waveguide. The program of instructions also includes program instructions for analyzing a lower portion of the waveguide including a bottom of the waveguide with an analytic method. The analyzing includes solving the governing equations that consider temperature effects on materials of the waveguide. A traction-free condition is enforced at the bottom of the waveguide.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1A shows a perspective view of a SAW device, in accordance with one embodiment of the present invention.

FIG. 1B shows a cross-sectional view of a periodic SAW device, in accordance with one embodiment of the present invention.

FIG. 2 shows an illustration of a displacement vector, in accordance with one embodiment of the present invention.

FIG. 3 shows a cross-sectional view of a periodic SAW device with dimensions and one period of the device with two simulation regions, in accordance with one embodiment of the present invention.

FIG. 4A shows a method of simulating a SAW device, in accordance with one embodiment of the present invention.

FIG. 4B shows a method of simulating a SAW device, in accordance with one embodiment of the present invention.

FIG. 5A shows simulation results of a SAW device, in accordance with one embodiment of the present invention.

FIG. 5B shows simulation results of a standard transverse wave (STW) device, in accordance with one embodiment of the present invention.

FIG. 6 shows a diagram of a system for the hybrid finite element method described, in accordance with one embodiment of the present invention.

### DETAILED DESCRIPTION

An invention is described for a method and a system for simulating a surface acoustic wave (SAW) on a structure. It will be obvious, however, to one skilled in the art, that the present invention may be practiced without some or all of these specific details. In other instances, well known process operations have not been described in detail in order not to unnecessarily obscure the present invention.

The embodiments of the present invention provide methods and systems for simulating a SAW and/or an LSAW device, while taking into account the temperature and thickness of the substrate into consideration. The method for simulating a SAW or an LSAW device utilizes a hybrid FE (HFE) method in one embodiment. The HFE simulation method uses the FE method in a region of the electrodes that includes a portion of the substrate and an analytic method for the remaining region of the SAW device's substrate. The surface acoustic wave is simulated by analyzing an upper portion of the waveguide including a periodic array of electrodes using a periodic finite element method by solving governing equations that take temperature effects into consideration. The simulation further involves analyzing a lower portion of the waveguide with an analytic method by solving the governing equations that take temperature effects into consideration. It should be appreciated that for SAW and LSAW devices that have high operating frequencies, using the hybrid finite element method that takes temperature effects into consideration results in more accurate results. In addition, the hybrid finite element also allows simulation of temperature effects on frequencies of SAW and LSAW devices.

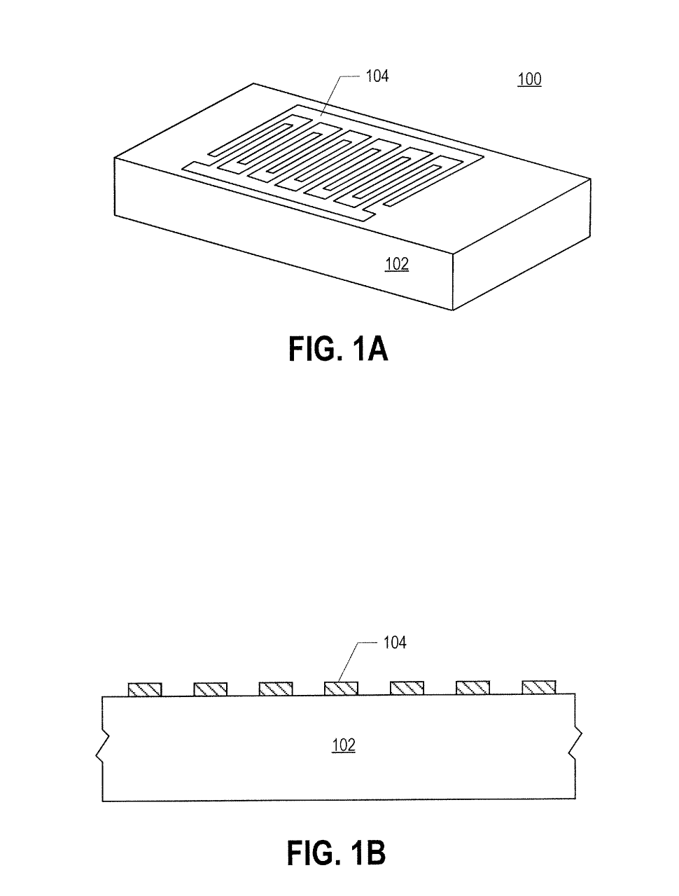

FIG. 1A shows a perspective view of a surface acoustic wave (SAW) device 100, in accordance with one embodiment of the present invention. The SAW device 100 includes a substrate 102 and a periodic array of electrodes 104 on the surface of the substrate. FIG. 1B shows a cross-sectional view of the SAW device 100, which is a waveguide, showing the substrate 102 and the periodic array of electrodes 104, in accordance with one embodiment of the present invention.

It should be noted that SAW devices can be used for a number of applications, such as filters, resonators, oscillators, etc., in electronic devices. SAW devices can have a periodic array of electrodes, as shown in FIGS. 1A and 1B. In general, the detection mechanism of a SAW device is an acoustic wave. As the acoustic wave propagates through the material of the SAW device, any changes to the characteristics of the propagation path affect the velocity and/or amplitude of the acoustic wave. Changes in velocity can be monitored by measuring the frequency or phase characteristics of the SAW device and can then be correlated to the corresponding physical quantity being measured. Applications of SAW devices include, but are not limited to, mobile communications (radio frequency filters and intermediate frequency filters), automotive applications (port resonators), medical applications (chemical sensors), and industrial and commercial applications (vapor, humidity, temperature, and mass sensors).

As mentioned above, FIG. 1B shows an embodiment of a periodic array of electrodes 104. The SAW device uses a piezoelectric material to generate the acoustic wave. It should be appreciated that piezoelectricity is the ability of certain materials to produce a voltage when subjected to mechanical stress. Conversely, the application of an electrical field creates mechanical stress in the piezoelectric material, which propagates through the SAW device 100 and is then converted back to an electric field for measurement. As shown in FIG. 1B, the SAW device 100 comprises of piezoelectric substrate 102, which is composed of a piezoelectric material. Exemplary piezoelectric materials include quartz (SiO₂), barium titanate (BaTiO₃), lithium tantalate (LiTaO₃), lithium niobate (LiNbO₃), gallium arsenide (GaAs), silicon carbide (SiC), langasite (LGS), zinc oxide (ZnO), aluminum nitride (AlN), lead zirconium titanate (PZT), polyvinylidene fluoride (PVdF), etc. Of course, any suitable piezoelectric material may be used for piezoelectric substrate 102. In one embodiment the piezoelectric substrate 102 is made of an anisotropic piezoelectric crystalline solid.

The SAW device 100 also includes electrodes 104 disposed on top of piezoelectric substrate 102. One skilled in the art will appreciate that electrodes 104 are made of conductive materials and are used to make contact with piezoelectric substrate 102. Exemplary electrode 104 materials include aluminum, copper, gold, conducting polymers, etc. A series of electrodes 104 disposed on top of piezoelectric substrate 102 create the alternating parallel grooves and ridges of the SAW device 100. FIG. 1B shows electrodes 104 having a rectangular shape when viewed from a side. However, electrodes 104 may have any suitable shape, such as a triangle, a trapezoid, a square, etc. In one embodiment, due to the different materials being used for the electrode 104 and the substrate 102, the thermal expansion coefficients for the electrode 104 and the substrate 102 are different. The electrode 104 and the substrate 102 respond differently to the increase or decrease of temperature. Therefore, it is important to include the temperature effect in the simulation of SAW/LSAW devices.

As mentioned above, one method of simulating a SAW device is to use the Finite Element (FE) method to solve the governing equations. The FE method involves creating a mesh. The mesh elements should be small enough to effectively simulate the behavior of the SAW device, which could require a large amount of computational resources. Further, the time it takes to finish the computation could be too long to be acceptable to meet engineering and manufacturing demands.

Another method of simulating a SAW device is to use a hybrid FE (HFE) method. A HFE method for simulating a SAW device would use the FE method in a region of the electrodes including a portion of the substrate and an analytic method for the remaining region of the SAW devices substrate. Examples of analytic methods that have been used include: a Periodic Green's Function, a Boundary Element Method (BEM) or a Spectral Domain Method (SDM). In the past these approaches have assumed a semi-infinite substrate. Thus, the thickness of the SAW device is not fully taken into account using these methods. However, a method of simulating a SAW device using a hybrid FE (HFE) is described in U.S. patent application Ser. No. 11/623,260, which takes into account the thickness of the substrate and the effect of reflections from the bottom of the substrate. U.S. patent application Ser. No. 11/623,260 has been incorporated by reference. In addition, this method takes into account all eight roots of Christoffel equations for each space harmonics are used for the basis of the expansion.

As described above, the current SAW and LSAW applications demand for broader working-temperature spectra. As dimensions of SAW and LSAW devices become smaller and the operating frequency of these devices increase, the temperature effect on the performance of SAW and LSAW devices becomes more prominent. For example, some SAW and/or LSAW devices for wireless applications operate at about 2.4 GHz. It is predicted that future operating frequencies could be 5.8 GHz or higher. Temperature has an impact on the properties of materials and can have a direct impact on the frequency of SAW and LSAW devices. A simulation of a SAW/LSAW device that considers temperature effect is presented in more detail below.

### Governing Equations

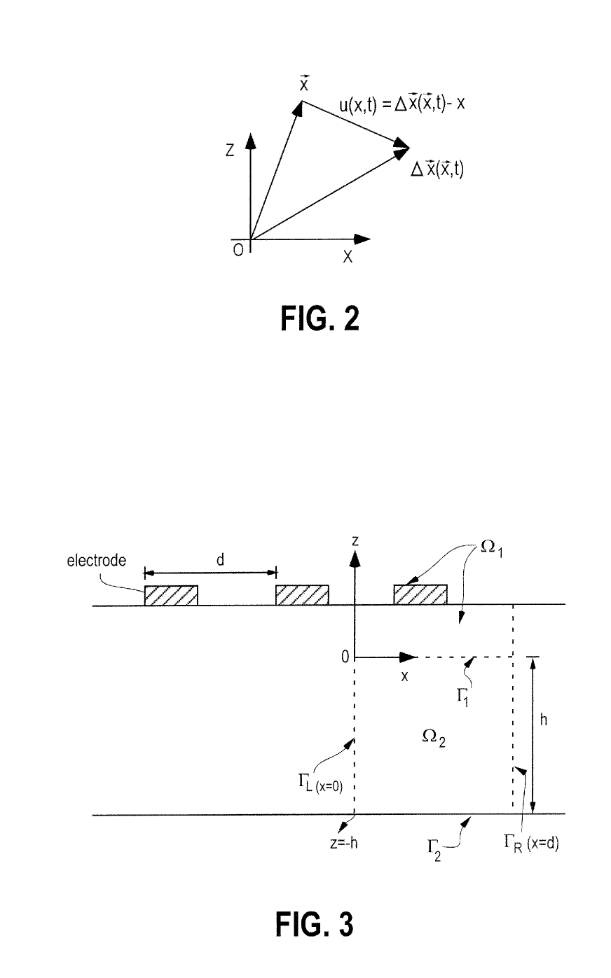

Simulation of the SAW device 100 may involve the simulation of time-varying deformation, i.e. vibration, of the material of the SAW device 100. The governing equations which describe the behavior of the SAW device 100 of FIG. 1A in terms of a displacement field \vec{u}(\vec{x},t)=\vec{x}−Δ\vec{x}(\vec{x},t) is illustrated in FIG. 2. The vector \vec{x} may be a position vector which describes points in the simulation space relative to an origin O. The vector Δ\vec{x} describes positions to which points in the simulation space have been displaced.

A simulation of the SAW device 100 may be based on one or more governing equations. Examples of such governing equations are Newton's equation of motion and Gauss' equation of charge conservation. A Lagrangian formulation for the frequency-temperature behavior of quartz may be utilized here. One such formulation is shown in equations (1). Equations (1) are an adaptation of Newton's equation of motion to the situation of an acoustic wave traveling through a substrate and Guass' equation of charge conservation.

$$\frac{\partial ( {t}_{ij} + {α}_{ik}^{θ} {t}_{jk} )}{\partial {x}_{j}} = ρ \frac{\partial {}_{}^{2}{u}{}_{i}^{}}{\partial {t}^{2}} - ρ {w}^{2} {u}_{i} \\ \frac{\partial {D}_{i}}{\partial {x}_{i}} = 0 \qquad ( 1 )$$

where w is the angular frequency, tᵢⱼ is the incremental stress tensor, ρ is the mass density, uᵢ is the incremental mechanical displacement, Dᵢ is the incremental electric displacement vector, and αᵢₖ^{θ} is the linear thermal coefficient defined in equation (2).

αᵢₖ^{θ}=θαᵢₖ⁽¹⁾+θ⁽²⁾+θ³αᵢₖ⁽³⁾ (2)

while θ=T−T₀ is the temperature change from the reference temperature, T₀=25° C., and the term αᵢₖ⁽ⁿ⁾ is the n-th order thermal expansion coefficient. In one embodiment, n=3.

The constitutive relations are listed in equations (3), as shown below.

tᵢⱼ=DᵢⱼₖₗSₖₗ−eₖᵢⱼ^{θ}Eₖ

Dᵢ=eₖᵢⱼ^{θ}sⱼₖ+∈ᵢⱼ^{θ}Eⱼ

Dᵢⱼₖₗ=Cᵢⱼₖₗ+Dᵢⱼₖₗ⁽¹⁾θ+Dᵢⱼₖₗ⁽²⁾θ²+Dᵢⱼₖₗ⁽³⁾θ³

eᵢⱼₖ^{θ}=eᵢⱼₖ(1+Teᵢⱼₖ⁽¹⁾θ+Teᵢⱼₖ⁽²⁾θ²+Teᵢⱼₖ⁽³⁾θ³)

∈ᵢₖ^{θ}=∈ᵢₖ(1+T∈ᵢₖ⁽¹⁾θ+T∈ᵢₖ⁽²⁾θ²+T∈ᵢₖ⁽³⁾θ³) (3)

where Cᵢⱼₖ is the elastic stiffness tensor, Dᵢⱼₖₗ⁽ⁿ⁾ is the n-th order temperature coefficient of the elastic tensor, eᵢⱼₖ the piezoelectric constants, Teᵢⱼₖ⁽ⁿ⁾ is the n-th order temperature coefficient of piezoelectric constants, ∈ᵢₖ is the dielectric permittivity at constant strain, and T∈ᵢₖ⁽ⁿ⁾ is the n-th order temperature coefficient of dielectric permittivity. sₖₗ, Eₖ are the incremental strain and incremental electric field, respectively.

The strain tensor and electric field are related to the displacement, u, and the electric potential, φ, by equations (4) shown below.

$${s}_{ij} = \frac{1}{2} ( {β}_{ik} \frac{\partial {u}_{k}}{\partial {x}_{i}} + {β}_{ik} \frac{\partial {u}_{k}}{\partial {x}_{j}} ) \\ {E}_{i} = - \frac{\partial φ}{\partial {x}_{i}} \\ {β}_{ik} = {δ}_{ik} + {α}_{ik}^{θ} \qquad ( 4 )$$

where the term ∈ᵢₖ is the Kronecker delta. It will be apparent to one skilled in the art that commonly used elastic stiffness constants, dielectric permittivity and piezoelectric constants for quartz are readily available. The coefficients of thermal expansions and other material constants are also readily available.

### Boundary Conditions

The boundary conditions are imposed as follows:

uᵢ=ūᵢ at Γᵤ

φ= φ̅ at Γ_{φ}

βᵢₖtₖⱼnⱼ=βᵢₖ T̅ᵢⱼnⱼ at Γ_{T}

Dᵢnᵢ= D̅ᵢnᵢ at Γ_{D} (5)

Assuming no variation in the z direction, FIG. 3 represents a two-dimensional problem domain for the computational analysis. Since the structure under study is periodic in the x direction with period d as shown, only a portion with one electrode is modeled for the analysis. The inhomogeneous region Ω₁ consists of an electrode and a portion of substrate immediately beneath it. The homogeneous region Ω₂ consists of the region below Ω₁ extending from Γ₁, which is an interface boundary between two regions, to the bottom of the substrate represented by Γ₂. The two regions are surrounded by Γ_{L}(x=0) and Γ_{R}(x=d) on which periodic conditions are applied as follows:

uᵢ(x=d)=exp(jβd)uᵢ(x=0)

φ(x=d)=exp(jβd)φ(x=0)

tᵢ₁(x=d)=exp(jβd)tᵢ₁(x=0)

D₁(x=d)=exp(jβd)D₁(x=0) (6)

where β is the complex wave number.

### Hybrid Variational Formulation

In the embodiments described herein, the temperature effect is incorporated for the first time into the variational form.

For the inhomogeneous region Ω₁, L₁ is expressed in equation (7).

$${L}_{1} = {\int }_{{Ω}_{1}}^{ } [ \frac{1}{2} ( {β}_{ik} {s}_{ij} {t}_{kj}^{*} + {β}_{ik} {s}_{ij}^{*} {t}_{kj} ) - {ω}^{2} ρ {u}_{i} {u}_{i}^{*} - \frac{1}{2} ( {E}_{i} {D}_{i}^{*} + {E}_{i}^{*} {D}_{i} ) ] d Ω - {\int }_{{Γ}_{T}}^{ } {n}_{j} {β}_{ik} {\overline{t}}_{kj}^{*} {u}_{i} d Γ - {\int }_{{Γ}_{D}}^{ } φ {\overline{D}}_{i}^{*} {n}_{i} d Γ \qquad ( 7 )$$

where * is for complex conjugate. The region is discretized with the conventional finite elements. For the homogeneous region Ω₂, L₂ is expressed in equation (8).

$${L}_{2} = - \frac{1}{2} {\int }_{{Γ}_{I}}^{ } ( {u}_{i} {β}_{ik} {t}_{kj}^{*} + {u}_{i}^{*} {β}_{ik} {t}_{kj} + φ {D}_{i}^{*} + {φ}^{*} {D}_{i} ) d Γ + {\int }_{{Γ}_{I}}^{ } ( {\tilde{u}}_{i} {β}_{ik} {t}_{kj}^{*} + {\tilde{u}}_{i}^{*} {β}_{ik} {t}_{kj} + \tilde{φ} {D}_{i}^{*} + {\tilde{φ}}^{*} {D}_{i} ) d Γ - {\int }_{{Γ}_{T}}^{ } ( {\tilde{u}}_{i} {β}_{ik} {\overline{t}}_{kj}^{*} + {\tilde{u}}_{i}^{*} {β}_{ik} {\overline{t}}_{kj} ) d Γ - {\int }_{{Γ}_{D}}^{ } ( \tilde{φ} {\overline{D}}_{i}^{*} + {\tilde{φ}}^{*} {\overline{D}}_{i} ) d Γ \qquad ( 8 )$$

where Lagrangian variables ũ and \tilde{φ} are the displacement and electric potential on the interfaces Γ₁.

The displacement and electric potential on the interface Γ₁ is expanded with finite element shape functions as follows:

ũ=ΣNᵢŨᵢ (9)

where N is the shape function vector and Ũᵢ is the solution vector.

In the substrate, field distributions are approximated by the superposition of the space harmonics:

$$\{ \begin{matrix}{u}_{x} \\ {u}_{y} \\ {u}_{z} \\ φ\end{matrix} \} = {\sum }_{n = - ∞}^{∞} {\sum }_{l = 1}^{8} {A}_{nl} ( \begin{matrix}{f}_{x , nl} \\ {f}_{y , nl} \\ {f}_{z , nl} \\ {f}_{φ , nl}\end{matrix} ) exp [ j ( {β}_{n} x + {k}_{nl} z - wt ) ] \qquad ( 10 )$$

where Aₙₗ is a coefficient of the 1-th partial wave corresponding to the n-th space harmonics, kₙₗ is the wave number of the partial wave, f_{i,nl} (i=x, y, z, φ) is the mode function of the partial waves, the components of the {A} vector are the unknown values of Aₙₗ, and βₙ=β₀+2nπ/p with β₀ being the complex wave number. Both kₙₗ and f_{i,nl} are obtained by solving Christoffel equations with temperature effects for each space harmonics. A detailed description for solving Christoffel equations is provided below.

Substituting equation (10) into equation (4) and using equation (3), equation (11), shown below, can be obtained.

$$\{ \begin{matrix}{T}_{xz} \\ {T}_{yz} \\ {T}_{zz} \\ {D}_{z}\end{matrix} \} = {\sum }_{n = - ∞}^{∞} {\sum }_{l = 1}^{8} {A}_{nl} ( \begin{matrix}{q}_{x , nl} \\ {q}_{y , nl} \\ {q}_{z , nl} \\ {q}_{D , nl}\end{matrix} ) exp [ j ( {β}_{n} x + {k}_{nl} z - wt ) ] \qquad ( 11 )$$

where

q_{x,nl}=

{c₁₅(β₁₁f_{x,nl}+β₁₂f_{y,nl}+β₁₃f_{z,nl})(jβₙ)+c₅₅(β₁₁f_{x,nl}+β₁₂f_{y,nl}+β₁₃f_{z,nl})(jkₙ)}

{c₅₆(β₂₁f_{x,nl}+β₂₂f_{y,nl}+β₂₃f_{z,nl})(jβₙ)+c₄₅(β₂₁f_{x,nl}+β₂₂f_{y,nl}+β₂₃f_{z,nl})(jkₙ)}

{c₅₅(β₃₁f_{x,nl}+β₃₂f_{y,nl}+β₃₃f_{z,nl})(jβₙ)+c₅₃(β₃₁f_{x,nl}+β₃₂f_{y,nl}+β₃₃f_{z,nl})(jkₙ)}

+{e₁₅^{θ}f_{D,nl}(jβₙ)+e₃₅^{θ}f_{D,nl}(jkₙ)}

q_{y,nl}=

{c₁₄(β₁₁f_{x,nl}+β₁₂f_{y,nl}+β₁₃f_{z,nl})(jβₙ)+c₄₅(β₁₁f_{x,nl}+β₁₂f_{y,nl}+β₁₃f_{z,nl})(jkₙ)}

{c₄₆(β₂₁f_{x,nl}+β₂₂f_{y,nl}+β₂₃f_{z,nl})(jβₙ)+c₄₄(β₂₁f_{x,nl}+β₂₂f_{y,nl}+β₂₃f_{z,nl})(jkₙ)}

{c₄₅(β₃₁f_{x,nl}+β₃₂f_{y,nl}+β₃₃f_{z,nl})(jβₙ)+c₃₄(β₃₁f_{x,nl}+β₃₂f_{y,nl}+β₃₃f_{z,nl})(jkₙ)}

+{e₁₄^{θ}f_{D,nl}(jβₙ)+e₃₄^{θ}f_{D,nl}(jkₙ)} (12)

q_{z,nl}=

{c₁₃(β₁₁f_{x,nl}+β₁₂f_{y,nl}+β₁₃f_{z,nl})(jβₙ)+c₃₅(β₁₁f_{x,nl}+β₁₂f_{y,nl}+β₁₃f_{z,nl})(jkₙ)}

{c₃₆(β₂₁f_{x,nl}+β₂₂f_{y,nl}+β₂₃f_{z,nl})(jβₙ)+c₃₄(β₂₁f_{x,nl}+β₂₂f_{y,nl}+β₂₃f_{z,nl})(jkₙ)}

{c₃₅(β₃₁f_{x,nl}+β₃₂f_{y,nl}+β₃₃f_{z,nl})(jβₙ)+c₃₃(β₃₁f_{x,nl}+β₃₂f_{y,nl}+β₃₃f_{z,nl})(jkₙ)}

+{e₁₃^{θ}f_{D,nl}(jβₙ)+e₃₃^{θ}f_{D,nl}(jkₙ)}

q_{D,nl}={e₃₁^{θ}f_{x,nl}(jβₙ)+e₃₅^{θ}f_{x,nl}(jkₙ)}+{e₃₆^{θ}f_{y,nl}(jβₙ)+e₃₄^{θ}f_{y,nl}(jkₙ)}

+{e₃₅^{θ}f_{z,nl}(jβₙ)+e₃₃^{θ}f_{z,nl}(jkₙ)}−{∈₃₁^{θ}f_{D,nl}(hβₙ)+∈₃₃^{θ}f_{D,nl}(jkₙ)} (12)

In practical numerical analysis, the infinite expansion is truncated into finite terms of space harmonics (2M). Therefore, in matrix formation, the Equations (10) and (11) can be written as equations (13) and (14) respectively.

$$\begin{matrix}\{ \begin{matrix}{u}_{x} \\ {u}_{y} \\ {u}_{z} \\ φ\end{matrix} \} = {\sum }_{n = - M - 1}^{M} {\sum }_{l = 1}^{8} {A}_{nl} ( \begin{matrix}{f}_{x , nl} \\ {f}_{y , nl} \\ {f}_{z , nl} \\ {f}_{φ , nl}\end{matrix} ) exp [ j ( {β}_{n} x + {k}_{nl} z - wt ) ] \\ = {[ F ]}_{4 \times ( 2 M \times 8 )} {\{ A \}}_{( 2 M \times 8 ) \times 1}\end{matrix} \qquad ( 13 )$$

$$\begin{matrix}\{ \begin{matrix}{T}_{xz} \\ {T}_{yz} \\ {T}_{zz} \\ {D}_{z}\end{matrix} \} = {\sum }_{n = - M - 1}^{M} {\sum }_{l = 1}^{8} {A}_{nl} ( \begin{matrix}{q}_{x , nl} \\ {q}_{y , nl} \\ {q}_{z , nl} \\ {q}_{D , nl}\end{matrix} ) exp [ j ( {β}_{n} x + {k}_{nl} z - wt ) ] \\ = {[ Q ]}_{4 \times ( 2 M \times 8 )} {\{ A \}}_{( 2 M \times 8 ) \times 1}\end{matrix} \qquad ( 14 )$$

Solving Christoffel Equations with Temperature Effects

The field solution ({uᵢ}) to the SAW under periodic condition is expanded into an infinite series of sinusoidal terms along the periodic direction. However, for practical reasons, in one embodiment only finite terms of space harmonics are chosen for computational analysis;

$${u}_{i} = {\sum }_{n = - M - 1}^{M} {f}_{in} exp [ j ( {β}_{n} x + {k}_{n} z - wt ) ] \qquad ( 15 )$$

Substituting equation (15) into the basic equations (equations (1)) lead to a symmetric matrix equation (16) to solve for each space harmonic.

$$( \begin{matrix}{R}_{11} ( n ) & {R}_{12} ( n ) & {R}_{13} ( n ) & {R}_{14} ( n ) \\ {R}_{21} ( n ) & {R}_{22} ( n ) & {R}_{23} ( n ) & {R}_{24} ( n ) \\ {R}_{31} ( n ) & {R}_{32} ( n ) & {R}_{33} ( n ) & {R}_{34} ( n ) \\ {R}_{41} ( n ) & {R}_{42} ( n ) & {R}_{43} ( n ) & {R}_{44} ( n )\end{matrix} ) \{ \begin{matrix}{f}_{1 n} \\ {f}_{2 n} \\ {f}_{3 n} \\ {f}_{4 n}\end{matrix} \} = 0 \qquad ( 16 )$$

R₁₁=A₁₁₁βₙ²+A₁₁₂kₙβₙ+A₁₁₃kₙ²−ρV₀²

R₂₁=A₂₁₁βₙ²+A₂₁₂kₙβₙ+A₂₁₃kₙ²

R₂₂=A₂₂₁βₙ²+A₂₂₂kₙβₙ+A₂₂₃kₙ²−ρV₀²

R₃₁=A₃₁₁βₙ²+A₃₁₂kₙβₙ+A₃₁₃kₙ²

R₃₂=A₃₂₁βₙ²+A₃₂₂kₙβₙ+A₃₂₃kₙ²

R₃₃=A₃₃₁βₙ²+A₃₂₂kₙβₙ+A₃₃₃kₙ²−ρV₀²

R₄₁=e₁₁^{θ}βₙ²+(e₁₅^{θ}+e₃₁^{θ})kₙβₙ+e₃₅^{θ}kₙ²

R₄₂=e₁₆^{θ}βₙ²+(e₁₄^{θ}+e₃₆^{θ})kₙβₙ+e₃₄^{θ}kₙ²

R₄₃=e₁₅^{θ}βₙ²+(e₁₃^{θ}+e₃₅^{θ})kₙβₙ+e₃₃^{θ}kₙ²

R₄₄=−(∈₁₁^{θ}βₙ²+2∈₁₃^{θ}kₙβₙ+∈₃₃^{θ}kₙ²)

where

$${A}_{111} = {β}_{11} ( {c}_{11} {β}_{11} + {c}_{15} {β}_{13} + {c}_{16} {β}_{12} ) + {β}_{12} ( {c}_{16} {β}_{11} + {c}_{56} {β}_{13} + {c}_{66} {β}_{12} ) + {β}_{13} ( {c}_{15} {β}_{11} + {c}_{55} {β}_{13} + {c}_{56} {β}_{12} ) \\ {A}_{112} = {β}_{11} \{ ( {c}_{13} {β}_{31} + {c}_{14} {β}_{21} + {c}_{15} {β}_{11} ) + ( {c}_{15} {β}_{11} + {c}_{55} {β}_{31} + {c}_{56} {β}_{21} ) \} + {β}_{12} \{ ( {c}_{36} {β}_{31} + {c}_{46} {β}_{21} + {c}_{56} {β}_{11} ) + ( {c}_{14} {β}_{11} + {c}_{45} {β}_{31} + {c}_{46} {β}_{21} ) \} + {β}_{13} \{ ( {c}_{35} {β}_{31} + {c}_{45} {β}_{21} + {c}_{55} {β}_{11} ) + ( {c}_{13} {β}_{11} + {c}_{35} {β}_{31} + {c}_{36} {β}_{21} ) \} \\ {A}_{113} = {β}_{11} ( {c}_{35} {β}_{31} + {c}_{45} {β}_{21} + {c}_{55} {β}_{11} ) + {β}_{12} ( {c}_{34} {β}_{31} + {c}_{44} {β}_{21} + {c}_{45} {β}_{11} ) + \\ {β}_{13} ( {c}_{33} {β}_{31} + {c}_{34} {β}_{21} + {c}_{35} {β}_{11} ) \\ {A}_{211} = {β}_{21} ( {c}_{11} {β}_{11} + {c}_{15} {β}_{31} + {c}_{16} {β}_{21} ) + {β}_{22} ( {c}_{16} {β}_{11} + {c}_{56} {β}_{31} + {c}_{66} {β}_{21} ) + {β}_{23} ( {c}_{15} {β}_{11 +} {c}_{55} {β}_{31} + {c}_{56} {β}_{21} ) \\ {A}_{212} = {β}_{21} \{ ( {c}_{13} {β}_{31} + {c}_{14} {β}_{21} + {c}_{15} {β}_{11} ) + ( {c}_{15} {β}_{11} + {c}_{55} {β}_{31} + {c}_{56} {β}_{21} ) \} + {β}_{22} \{ ( {c}_{36} {β}_{31} + {c}_{46} {β}_{21} + {c}_{56} {β}_{11} ) + ( {c}_{14} {β}_{11} + {c}_{45} {β}_{31} + {c}_{46} {β}_{21} ) \} + {β}_{23} \{ ( {c}_{35} {β}_{31} + {c}_{45} {β}_{21} + {c}_{55} {β}_{11} ) + ( {c}_{13} {β}_{11} + {c}_{35} {β}_{31} + {c}_{36} {β}_{21} ) \} \\ {A}_{213} = {β}_{21} ( {c}_{35} {β}_{31} + {c}_{45} {β}_{21} + {c}_{55} {β}_{11} ) + {β}_{22} ( {c}_{34} {β}_{31} + {c}_{44} {β}_{21} + {c}_{45} {β}_{11} ) + {β}_{23} ( {c}_{33} {β}_{31} + {c}_{34} {β}_{21} + {c}_{35} {β}_{11} ) \\ {A}_{221} = {β}_{21} ( {c}_{11} {β}_{12} + {c}_{15} {β}_{32} + {c}_{16} {β}_{22} ) + {β}_{22} ( {c}_{16} {β}_{12} + {c}_{56} {β}_{32} + {c}_{66} {β}_{22} ) + {β}_{23} ( {c}_{15} {β}_{12} + {c}_{55} {β}_{32} + {c}_{56} {β}_{22} ) \\ {A}_{222} = {β}_{21} \{ ( {c}_{13} {β}_{32} + {c}_{14} {β}_{22} + {c}_{15} {β}_{12} ) + ( {c}_{15} {β}_{12} + {c}_{55} {β}_{32} + {c}_{56} {β}_{22} ) \} + {β}_{22} \{ ( {c}_{36} {β}_{32} + {c}_{46} {β}_{22} + {c}_{56} {β}_{12} ) + ( {c}_{14} {β}_{12} + {c}_{45} {β}_{32} + {c}_{46} {β}_{22} ) \} + {β}_{23} \{ ( {c}_{35} {β}_{32} + {c}_{45} {β}_{22} + {c}_{55} {β}_{12} ) + ( {c}_{13} {β}_{12} + {c}_{35} {β}_{32} + {c}_{36} {β}_{22} ) \} \\ {A}_{223} = {β}_{21} ( {c}_{35} {β}_{32} + {c}_{45} {β}_{22} + {c}_{55} {β}_{21} ) + {β}_{22} ( {c}_{34} {β}_{32} + {c}_{44} {β}_{22} + {c}_{45} {β}_{12} ) + {β}_{23} ( {c}_{33} {β}_{32} + {c}_{34} {β}_{22} + {c}_{35} {β}_{12} ) \\ {A}_{311} = {β}_{31} ( {c}_{11} {β}_{11} + {c}_{15} {β}_{31} + {c}_{16} {β}_{21} ) + {β}_{32} ( {c}_{16} {β}_{11} + {c}_{56} {β}_{31} + {c}_{66} {β}_{21} ) + {β}_{33} ( {c}_{15} {β}_{11} + {c}_{55} {β}_{31} + {c}_{56} {β}_{21} ) \\ {A}_{312} = {β}_{31} \{ ( {c}_{13} {β}_{31} + {c}_{14} {β}_{21} + {c}_{15} {β}_{11} ) + ( {c}_{15} {β}_{11} + {c}_{55} {β}_{31} + {c}_{56} {β}_{21} ) \} + {β}_{32} \{ ( {c}_{36} {β}_{31} + {c}_{46} {β}_{21} + {c}_{56} {β}_{11} ) + ( {c}_{14} {β}_{11} + {c}_{45} {β}_{31} + {c}_{46} {β}_{21} ) \} + {β}_{33} \{ ( {c}_{35} {β}_{31} + {c}_{45} {β}_{21} + {c}_{55} {β}_{11} ) + ( {c}_{13} {β}_{11} + {c}_{35} {β}_{31} + {c}_{36} {β}_{21} ) \} \\ {A}_{313} = {β}_{31} ( {c}_{35} {β}_{31} + {c}_{45} {β}_{21} + {c}_{55} {β}_{11} ) + {β}_{32} ( {c}_{34} {β}_{31} + {c}_{44} {β}_{21} + {c}_{45} {β}_{11} ) + {β}_{33} ( {c}_{33} {β}_{31} + {c}_{34} {β}_{21} + {c}_{35} {β}_{11} ) \\ {A}_{321} = {β}_{31} ( {c}_{11} {β}_{12} + {c}_{15} {β}_{32} + {c}_{16} {β}_{22} ) + {β}_{32} ( {c}_{16} {β}_{12} + {c}_{56} {β}_{32} + {c}_{66} {β}_{22} ) + {β}_{33} ( {c}_{15} {β}_{12} + {c}_{55} {β}_{32} + {c}_{56} {β}_{22} ) \\ {A}_{322} = {β}_{31} \{ ( {c}_{13} {β}_{32} + {c}_{14} {β}_{22} + {c}_{15} {β}_{12} ) + ( {c}_{15} {β}_{12} + {c}_{55} {β}_{32} + {c}_{56} {β}_{22} ) \} + {β}_{32} \{ ( {c}_{36} {β}_{32} + {c}_{46} {β}_{22} + {c}_{56} {β}_{12} ) + ( {c}_{14} {β}_{12} + {c}_{45} {β}_{32} + {c}_{46} {β}_{22} ) \} + {β}_{33} \{ ( {c}_{35} {β}_{32} + {c}_{45} {β}_{22} + {c}_{55} {β}_{12} ) + ( {c}_{13} {β}_{12} + {c}_{35} {β}_{32} + {c}_{36} {β}_{22} ) \} \\ {A}_{323} = {β}_{31} ( {c}_{35} {β}_{32} + {c}_{45} {β}_{22 } + {c}_{55} {β}_{12} ) + {β}_{32} ( {c}_{34} {β}_{32} + {c}_{44} {β}_{22} + {c}_{45} {β}_{12} ) + {β}_{33} ( {c}_{33} {β}_{32} + {c}_{34} {β}_{22} + {c}_{35} {β}_{12} ) \\ {A}_{331} = {β}_{31} ( {c}_{11} {β}_{13} + {c}_{15} {β}_{33} + {c}_{16} {β}_{23} ) + {β}_{32} ( {c}_{16} {β}_{13} + {c}_{56} {β}_{33} + {c}_{66} {β}_{23} ) + {β}_{33} ( {c}_{15} {β}_{13} + {c}_{55} {β}_{33} + {c}_{56} {β}_{23} ) \\ {A}_{332} = {β}_{31} \{ ( {c}_{13} {β}_{33} + {c}_{14} {β}_{23} + {c}_{15} {β}_{13} ) + ( {c}_{15} {β}_{13} + {c}_{55} {β}_{33} + {c}_{56} {β}_{23} ) \} + {β}_{32} \{ ( {c}_{36} {β}_{33} + {c}_{46} {β}_{23} + {c}_{56} {β}_{13} ) + ( {c}_{14} {β}_{13} + {c}_{45} {β}_{33} + {c}_{46} {β}_{23} ) \} + {β}_{33} \{ ( {c}_{35} {β}_{33} + {c}_{45} {β}_{23} + {c}_{55} {β}_{13} ) + ( {c}_{13} {β}_{13} + {c}_{35 } {β}_{33} + {c}_{36} {β}_{23} ) \} \\ {A}_{333} = {β}_{31} ( {c}_{35} {β}_{33} + {c}_{45} {β}_{23} + {c}_{55} {β}_{13} ) + {β}_{32} ( {c}_{34} {β}_{33} + {c}_{44} {β}_{23} + {c}_{45} {β}_{13} ) + {β}_{33} ( {c}_{33} {β}_{33} + {c}_{34} {β}_{23} + {c}_{35} {β}_{13} ) \qquad ( 18 )$$

For a nontrivial solution of equation (16), the determinant of the coefficient matrix is zero, which leads an eighth order polynomial for kₙ whose coefficients are function of βₙ. Alternatively, the equation can be transformed to a nonlinear eigenvalue equation for kₙ, (19). Equation (19) is converted to a generalized linear eigenvalue problem, (20), by introducing an additional unknown eivenvector vector {v}. Both equations are shown below.

[kₙ²[A]+kₙ[B]+[C]]{u}=0

where

{u}={f₁ₙf₂ₙf₃ₙf₄ₙ}^{T} (19)

$$[ \begin{matrix}{0}_{4 \times 4} & {I}_{4 \times 4} \\ - {[ A ]}^{- 1} [ C ] & - {[ A ]}^{- 1} [ B ]\end{matrix} ] \{ \begin{matrix}u \\ v\end{matrix} \} = {k}_{n} \{ \begin{matrix}u \\ v\end{matrix} \} \qquad ( 20 )$$

where 0_{4×4} is a 4×4 zero matrix and I_{4×4} is a 4×4 identity matrix.

### Adaptive Wave Component Amplitude Allocation

Due to the finite thickness of substrate and the reflected waves from the bottom of the substrate, all 8 roots should be used for the space harmonic expansion. Details of how the equations are derived are described in U.S. patent application Ser. No. 11/623,260. In the embodiments described herein, the final equations are rewritten to simplify the presentation. The traction-free condition is enforced for each space harmonics at z=−h.

$$0 = \{ \begin{matrix}{T}_{xz} \\ {T}_{yz} \\ {T}_{zz} \\ {D}_{z}\end{matrix} \} = exp [ j ( {β}_{n} x - wt ) ] {\sum }_{l = 1}^{8} {A}_{nl} ( \begin{matrix}{q}_{x , nl} \\ {q}_{y , nl} \\ {q}_{z , nl} \\ {q}_{D , nl}\end{matrix} ) {exp [ j ( {k}_{nl} z ) ]}_{z = - h} \qquad ( 21 )$$

At the boundary, z=−h, the matrix [Q] is divided into two parts depending on the signs of Im(kₙₗ) so that all 8 harmonics can satisfy the traction-free boundary condition. kₙₗ is sorted and regrouped according to the signs of imaginary part of kₙₗ, as shown in equation (22).

$${k}_{nl} = \{ \begin{matrix}{k}_{nl}^{-} & l = 1 \sim p & for Im ( {k}_{nl} ) < 0 \\ {α}_{nl} + {jξ}_{nl} & l = ( p + 1 ) \sim 8 & for Im ( {k}_{nl} ) > 0\end{matrix} \qquad ( 22 )$$

where p is the number of kₙₗ which has negative imaginary part, kₙₗ⁻ represents the case of Im(kₙₗ)<0, αₙₗ is the real part of kₙₗ for Im(kₙₗ)>0 and ξₙₗ is the imaginary part of kₙₗ for Im(kₙₗ)>0.

Therefore, at boundary, z=−h, equation (10) becomes

$$0 = {\sum }_{l = 1}^{p} {A}_{nl} ( \begin{matrix}{q}_{x , nl} \\ {q}_{y , nl} \\ {q}_{z , nl} \\ {q}_{D , nl}\end{matrix} ) exp [ - j ( {k}_{nl}^{-} ) h ] + {\sum }_{l = p + 1}^{8} {\overline{A}}_{nl} ( \begin{matrix}{q}_{x , nl} \\ {q}_{y , nl} \\ {q}_{z , nl} \\ {q}_{D , nl}\end{matrix} ) exp [ - j {α}_{nl} h ] \qquad ( 23 )$$

=[Q₁]_{z=-h}{A}+[Q₂]_{z=-h}{Ā}

where Āₙₗ is exp(ξₙₗh) Aₙₗ. {Ā} can be written in terms of {A}, as shown in equation (24).

{Ā}=−[Q₂]_{z=-h}⁻¹[Q₁]_{z=-h}{A}=[R]_{z=-h}{A} (24)

It is noted that one is always able to find four roots that have negative imaginary part, that is, p=4. To overcome a numerical overflow due to the term exp[ξₙₗh] when ξₙₗ≠0 and the thickness (h)>1.0, an adaptive wave component amplitude allocation method is previously invented to merge the term into the unknown Aₙₗ. Further details of the adaptive wave component amplitude allocation method is described in U.S. patent application Ser. No. 11/623,260, which is incorporated by reference. It can be easily shown that the term exp(ξₙₗh) causes numerical overflow when ξₙₗ≠0 and the thickness h greater than one, h>1. Numerical overflow is thus avoided by replacing the evaluation of the exponential term exp(ξₙₗh) with evaluation of [R]_{z}=₋ₕ.

The methodology used above may also be applied to equations (13) and (14). Thus, yielding equation (25) and (26) below.

$$\begin{matrix}\{ \begin{matrix}{u}_{x} \\ {u}_{y} \\ {u}_{z} \\ φ\end{matrix} \} = {[ F ]}_{4 \times ( 2 M \times 8 )} {\{ A \}}_{( 2 M \times 8 ) \times 1} = [ {F}_{1} ] \{ A \} + [ {F}_{2} ] \{ \overline{A} \} \\ = 〈 [ {F}_{1} ] + {[ {F}_{2} ] [ R ]}_{z = - h} 〉 \{ A \}\end{matrix} \qquad ( 25 )$$

$$And \begin{matrix}\{ \begin{matrix}{T}_{xz} \\ {T}_{yz} \\ {T}_{zz} \\ {D}_{z}\end{matrix} \} = {[ G ]}_{4 \times ( 2 M \times 8 )} {\{ A \}}_{( 2 M \times 8 ) \times 1} = [ {G}_{1} ] \{ A \} + [ {G}_{2} ] \{ \overline{A} \} \\ = 〈 [ {G}_{1} ] + {[ {G}_{2} ] [ R ]}_{z = - h} 〉 \{ A \}\end{matrix} \qquad ( 26 )$$

From equation (7), the functional L₁ for region Ω₁, the following matrix equation (27) can be obtained using standard methods. Wherein: matrix [K_{FE}] is the finite element matrix; the vector {ũᵢ} is composed of the values of ũᵢ at the boundary Γ₁; the vector {\tilde{φ}ᵢ} is composed of the values of \tilde{φ}ᵢ at the boundary Γ₁; and the vector {u₀} is composed of those values at nodes other than boundary Γ₁.

$$[ {K}_{FE} ] \{ \begin{matrix}\{ {u}_{0} \} \\ \{ {\tilde{u}}_{x} \} \\ \{ {\tilde{u}}_{y} \} \\ \{ {\tilde{u}}_{z} \} \\ \{ \tilde{φ} \}\end{matrix} \} = \{ \begin{matrix}0 \\ - {\int }_{{Γ}_{1}}^{ } \{ N \} {T}_{xz} d x \\ - {\int }_{{Γ}_{1}}^{ } \{ N \} {T}_{yz} d x \\ - {\int }_{{Γ}_{1}}^{ } \{ N \} {T}_{zz} d x \\ - {\int }_{{Γ}_{1}}^{ } \{ N \} {D}_{z} d x\end{matrix} \} \qquad ( 27 )$$

From equation (8), the functional L₂ for region Ω₂, matrix equation (28) can also be obtained using hybrid variational principles.

$${L}_{2} = - {\{ {A}^{t} \}}^{T} [ H ] \{ A \} + {\{ {A}^{t} \}}^{T} [ K ] \{ {\tilde{u}}_{p} \} + {\{ {\tilde{u}}_{p}^{t} \}}^{T} [ {K}^{t} ] \{ A \} - {\int }_{{Γ}_{T}}^{ } {\sum }_{i} ( {\tilde{u}}_{i} {\overline{T}}_{iz}^{t} + {\tilde{u}}_{i}^{t} {\overline{T}}_{iz} ) d x - {\int }_{{Γ}_{D}}^{ } {\sum }_{i} ( \tilde{φ} {\overline{D}}_{iz}^{t} + {\tilde{φ}}_{i}^{t} {\overline{D}}_{iz} ) d x \qquad ( 28 )$$

where the matrices [H] and [K] are expressed as shown in equations (29).

$$\begin{matrix}[ H ] = \frac{1}{2} {\int }_{{Γ}_{I}}^{ } {[ F ]}^{⊥} [ Q ] d x + \frac{1}{2} {\int }_{{Γ}_{I}}^{ } {[ Q ]}^{⊥} [ F ] d x \\ [ K ] = {\int }_{{Γ}_{I}}^{ } {[ Q ]}^{⊥} [ N ] d x\end{matrix} \qquad ( 29 )$$

where ⊥ denotes a complex conjugate transpose. The matrices [F] and [Q] were previously defined in equations (13) and (14). The functional L₂ for region Ω₂ as defined in equation (28) can be made stationary with respect to {A} producing equation (30).
Making this functional stationary with respect to {A} yields

[H]{A}=[K]{Ũ} (30)

Finally, a matrix equation (31) can be obtained by eliminating the unknown vector {A}.

$$[ {K}^{T} {H}^{- 1} K ] \{ \begin{matrix}\{ {\tilde{u}}_{x} \} \\ \{ {\tilde{u}}_{y} \} \\ \{ {\tilde{u}}_{z} \} \\ \{ \tilde{φ} \}\end{matrix} \} = \{ \begin{matrix}{\int }_{{Γ}_{1}}^{ } \{ N \} {T}_{xz} d x \\ {\int }_{{Γ}_{1}}^{ } \{ N \} {T}_{yz} d x \\ {\int }_{{Γ}_{1}}^{ } \{ N \} {T}_{zz} d x \\ {\int }_{{Γ}_{1}}^{ } \{ N \} {D}_{z} d x\end{matrix} \} \qquad ( 31 )$$

Equations (27) and (31) can be used to generate a system of linear homogeneous equations. To get a nontrivial solution of such system, the determinant is set to zero. Thus an equation for determining a complex value of wave number β is obtained. In real computation; however, dispersion relations can be obtained by searching the minimum of the absolute value of the determinant.

### Periodic Boundary Condition

Excluding nodes on the interface boundary Γ₁, Equation (16) can be rewritten as equation (32).

$$[ \begin{matrix}{K}_{II} & {K}_{IA} & {K}_{IB} \\ {K}_{AI} & {K}_{AA} & {K}_{AB} \\ {K}_{BI} & {K}_{BA} & {K}_{BB}\end{matrix} ] [ \begin{matrix}{U}_{I} \\ {U}_{A} \\ {U}_{B}\end{matrix} ] - {w}^{2} [ \begin{matrix}{M}_{II} & {M}_{IA} & {M}_{IB} \\ {M}_{AI} & {M}_{AA} & {M}_{AB} \\ {M}_{BI} & {M}_{BA} & {M}_{BB}\end{matrix} ] [ \begin{matrix}{U}_{I} \\ {U}_{A} \\ {U}_{B}\end{matrix} ] = [ \begin{matrix}O \\ {R}_{A} \\ {R}_{B}\end{matrix} ] \qquad ( 32 )$$

where U_{A} and U_{B} notes the nodes on the left and right end boundaries, respectively, while U₁ represents all other nodes in the model. Due to the periodicity of the geometry, using the general form of Floquet's theorem, the boundary conditions are imposed as follows:

U_{B}(x=d)=ζU_{A}(x=0)

R_{B}(x=d)=−ζR_{A}(x=0)

where

ζ=exp(jβd) (33)

on the planes x=0, d. Here β is the complex wave number in the x direction.

The matrix equation (32) can be simplified by eliminating the third row (R_{B} and U_{B}) by using equations (33) to become equation (34), as shown below.

$$[ \begin{matrix}{K}_{II} & {K}_{IA} + Ϛ {K}_{IB} \\ {K}_{AI} + exp ( - jβ d ) {K}_{BI} & \begin{matrix}{K}_{AA} + {K}_{BB} + \\ Ϛ {K}_{AB} + exp ( - jβ d ) {K}_{BA}\end{matrix}\end{matrix} ] [ \begin{matrix}{U}_{I} \\ {U}_{A}\end{matrix} ] - {w}^{2} [ \begin{matrix}{M}_{II} & {M}_{IA} + Ϛ {M}_{IB} \\ {M}_{AI} + exp ( - jβ d ) {M}_{BI} & \begin{matrix}{M}_{AA} + {M}_{BB} + \\ Ϛ {M}_{AB} + exp ( - jβ d ) {M}_{BA}\end{matrix}\end{matrix} ] [ \begin{matrix}{U}_{I} \\ {U}_{A}\end{matrix} ] = \{ 0 \} \qquad ( 34 )$$

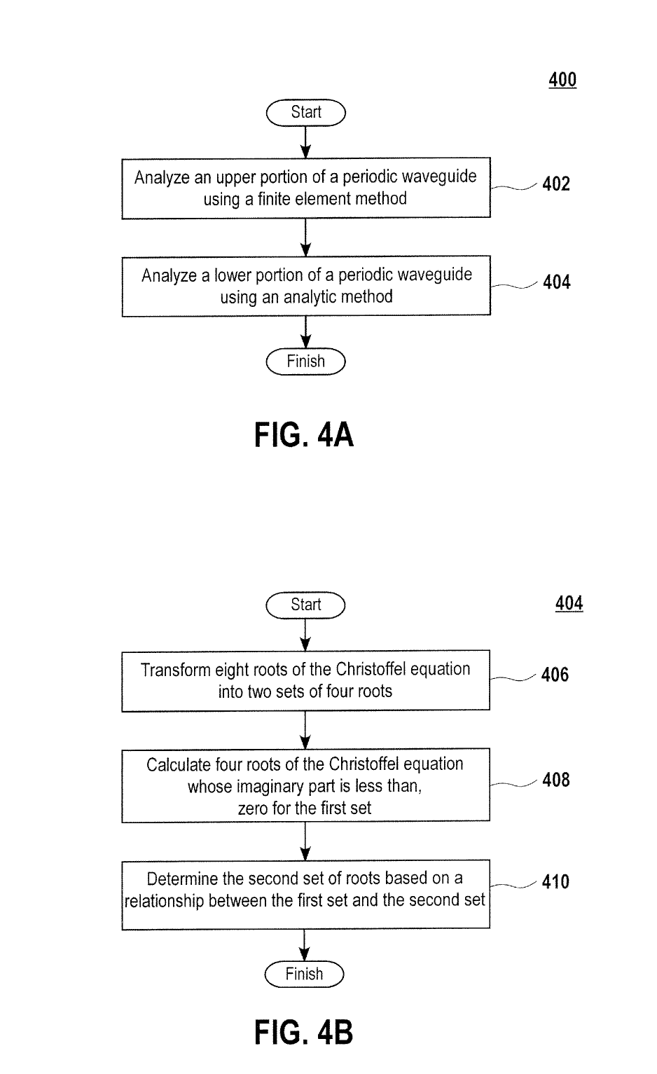

The invention described above may also be described in a method 400 illustrated in FIG. 4A. The goal of the method 400 is to describe the physical and electrical characteristics of a device. An exemplary device upon which the method 400 may be used is the periodic SAW device 100. The method 400 may involve a step 402 in which an upper portion of the device is analyzed using a hybrid finite element (HFE) method. The HFE simulation method uses the FE method in a region of the electrodes including a portion of the substrate and an analytic method for the remaining region of the SAW devices substrate. An aspect of the present invention is simulating a SAW in a periodic waveguide. The SAW is simulated by analyzing an upper portion of the waveguide including a periodic array of electrodes using a periodic finite element method by solving governing equations that take temperature effects into consideration. Temperature affects the values of the constants of these governing equations. The simulation further involves analyzing a lower portion of the waveguide, including a bottom of the waveguide, with an analytic method by solving the governing equations that take temperature effects into consideration. For SAW and LSAW devices that have high operating frequencies, using the hybrid finite element method that takes temperature effects into consideration yields more accurate results. In addition, the hybrid finite element also allows simulation of temperature effects on frequencies of SAW and LSAW devices.

An example of such an upper portion is Ω₁ shown in FIG. 3. The method 400 may also involve the step 402 in which a lower portion of the device is analyzed using an analytic method. An example of such a lower portion is Ω₂ shown in FIG. 3. The upper portion and the lower portion share an interface. An example of such an interface is Γ₁ shown in FIG. 3.

The method 404 for analyzing the lower portion of the device is illustrated in FIG. 4B. The method 404 may involve a transformative operation 406 in which a set consisting of eight solutions to the Christoffel equation is transformed into two sets. A calculation operation 408 may consist of forming a first set of the two sets consisting of four solutions in which the imaginary part is less than zero and a second set. The second set may be found by forming a relationship between the first set and the second set and determining the second set from this relationship in an operation 410. The solutions to the Christoffel equation are representative of the behavior of the device.

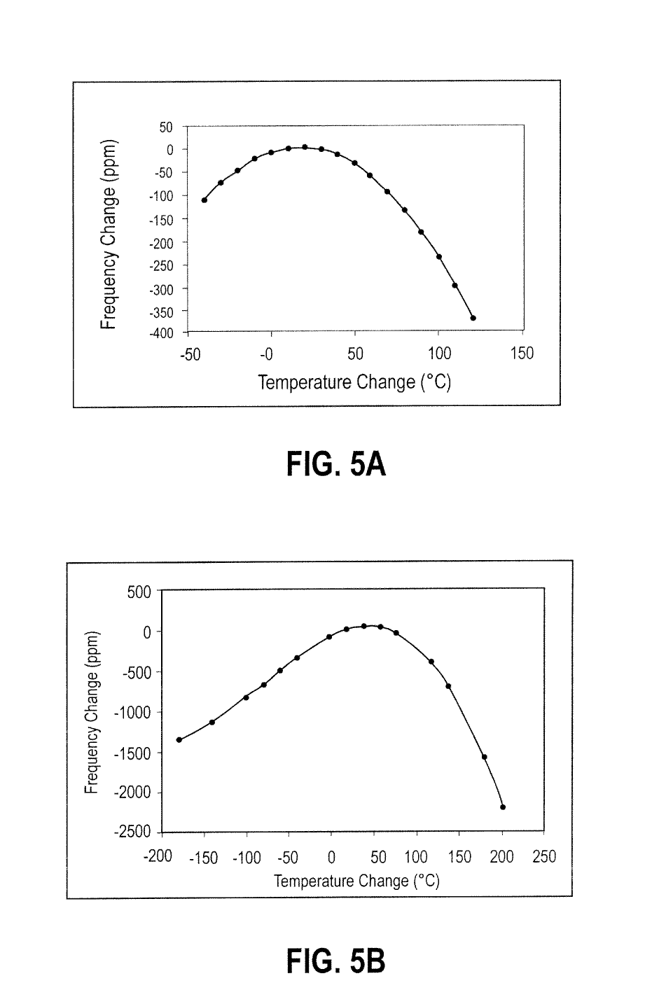

FIG. 5A shows simulation results of frequency change as a function of temperature of a SAW device with the orientation of the quartz substrate being (0°, 123°, 0°). FIG. 5B shows simulation results of frequency change as a function of temperature of a surface transverse wave (STW) device with the orientation of the quartz substrate being (0°, 129°, 90°). The h values of both cases are 400 μm. The reference point is room temperature (25° C.). The results in FIGS. 5A and 5B show that the frequency change of these two devices near room temperature (25° C.) being relatively small compared to higher or lower temperatures. When the device temperature deviates from room temperature, the frequency change increases dramatically.

It should be appreciated that for SAW and LSAW devices that have high operating frequencies, using the hybrid finite element method that takes temperature effects into consideration results in more accurate answers. In addition, the hybrid finite element also allows simulation of temperature effects on frequencies of SAW and LSAW devices.

Although the discussion above is focused on a hybrid method using a FE method in a region of the electrodes including a portion of the substrate and an analytic method for the remaining region of the SAW device's substrate. The concept of the current invention can also be applied to a hybrid method using a meshfree method to replace the FE method. Details of the meshfree method can be found in U.S. Patent Application No. 2006/0149513, filed on Jan. 5, 2005 and entitled “Method and System for Simulating a Surface Acoustic Wave on a Modeled Structure,” which is incorporated herein by reference.

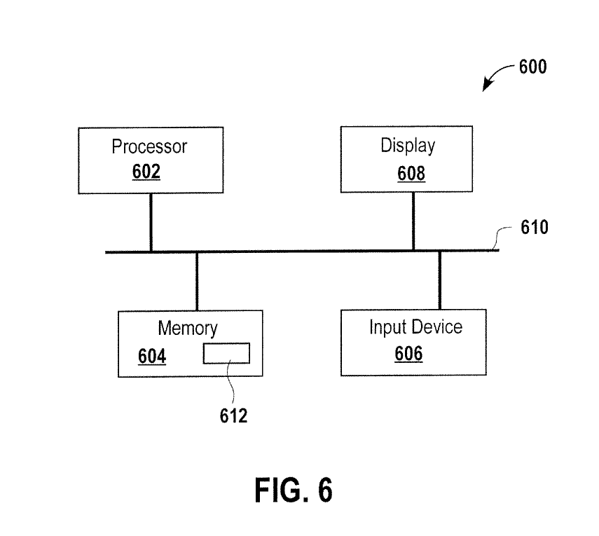

One skilled in the art will appreciate that the functionality described above for simulating a SAW on a corrugated structure may be incorporated into a computer readable medium for use in a computer system. FIG. 6 is a simplified block diagram of a high level overview of a computer system for simulating a SAW on a structure, in accordance with one embodiment of the present invention. As shown in FIG. 6, computer system 600 includes processor 602, display 608 (e.g., liquid crystal (LCD) displays, thin-film transistor (TFT) displays, cathode ray tube (CRT) monitors, etc.), memory 604 (e.g., static access memory (SRAM), dynamic random access memory (DRAM), hard disk drives, optical disc drives, etc.), and input device 606 (e.g., mouse, keyboard, etc.). Each of these components may be in communication through common bus 610. In one exemplary embodiment, an analysis program 612 stored in memory 604 and executed by processor 602 includes program instructions for applying the hybrid method to a periodic structure and program instructions for solving a set of equations simultaneously to obtain numerical results.

In the illustrated system, all major system components connect to bus 610 which may represent more than one physical bus. However, various system components may or may not be in physical proximity to one another. For example, input data and/or output data may be remotely transmitted from one physical location to another. Also, programs that implement various aspects of this invention may be accessed from a remote location (e.g., a server) over a network. Such data and/or programs may be conveyed through any of a variety of machine-readable medium. Machine-readable medium are divided into two groups, one being storage medium and the other being transmission medium. Storage medium includes magnetic tape or disk or optical disc. Transmission medium includes any other suitable electromagnetic carrier signals including infrared signals.

The present invention may be conveniently implemented with software. However, alternative implementations are certainly possible, including a hardware and/or a software/hardware implementation. Any hardware-implemented functions may be realized using ASIC(s), digital signal processing circuitry, or the like. Accordingly, the “means” terms in the claims are intended to cover both software and hardware implementations. Similarly, the term “machine-readable medium” as used herein includes software, hardware having a program of instructions hardwired thereon, or combination thereof. With these implementation alternatives in mind, it is to be understood that the figures and accompanying description provide the functional information one skilled in the art would require to write program code (i.e., software) or to fabricate circuits (i.e., hardware) to perform the processing required.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for simulating a surface acoustic wave in a waveguide taking temperature effects into consideration, comprising the operations of:
analyzing an upper portion of the waveguide including an array of electrodes with a finite element method, the analyzing including solving governing equations that consider temperature effects on materials of the waveguide; and
analyzing a lower portion of the waveguide including a bottom of the waveguide with an analytic method, the analyzing including solving the governing equations that consider temperature effects on materials of the waveguide.

2. The process of claim 1, wherein a traction-free condition is enforced at the bottom of the waveguide.

3. The method of claim 1, wherein the governing equations include Newton's equation of motion and Gauss's equation of charge conservation, and wherein different temperatures yield different constants in the governing equations.

4. The method of claim 3, wherein the array of electrodes and a substrate of the waveguide are made of different materials with different thermal expansion coefficients.

5. The method of claim 4, wherein all non-trivial roots of Christoffel equations of each space harmonic term are used.

6. The method of claim 1, wherein the analytic method involves finding a first four non-trivial analytic solutions to the Christoffel equation in which the imaginary part is less than zero and determining four additional solutions based on the first four solutions.

7. The method of claim 1, wherein the consideration of temperature effects includes third order thermal expansion coefficients.

8. The method of claim 1, wherein the array of electrodes is made of a material selected from a group consisting of aluminum, copper, gold, and conducting polymers.

9. The method of claim 1, wherein the lower portion of the waveguide is a portion of the substrate made of a material selected from a group consisting of quartz (SiO₂), barium titanate (BaTiO₃), lithium tantalate (LiTaO₃), lithium niobate (LiNbO₃), gallium arsenide (GaAs), silicon carbide (SiC), langasite (LGS), zinc oxide (ZnO), aluminum nitride (AlN), lead zirconium titanate (PZT), and polyvinylidene fluoride (PVdF).

10. The method of claim 9, wherein the upper portion of the waveguide includes an individual electrode and a remaining portion of the substrate.

11. The method of claim 1, wherein the upper portion and the lower portion of the waveguide share an interface.

12. An analytic method for analyzing acoustic waves traveling through a solid state medium of a finite extant by calculating a set of eight roots of Christoffel equations taking temperature effects into consideration in a solution space representative of the solid state medium, comprising the operations of:
transforming the set of eight roots of the Christoffel equations that consider temperature effects on materials of the waveguide into two sets of four roots, a first set and a second set based on the sign of the imaginary part of each root, wherein different temperatures yield different constants in the Christoffel equations, and wherein:
the first set consists of the four calculated roots of the Christoffel equations whose imaginary part is less than zero, and
the second set consists of four roots of the Christoffel equations which are not in the first set;
determining the first set by calculating four non-trivial analytic solutions to the Christoffel equations whose imaginary part are less than zero, based on boundary conditions of the solution space with a bottom surface of the solution space being traction free; and
determining the second set of roots based on the boundary conditions and a relationship between the first set and the second set.

13. The analytic method of claim 12, wherein the solid state medium is an anisotropic piezoelectric crystalline solid.

14. The analytic method of claim 12, wherein the surface acoustic wave traveling through a solid state medium which is part of a surface acoustic wave device or a leaky surface acoustic wave device.

15. The analytic method of claim 12, wherein the eight non-trivial analytic solutions are found from a system of linear homogenous equations.

16. The analytic method of claim 12, wherein the array of electrodes is made of a material selected from a group consisting of aluminum, copper, gold, and conducting polymers, and wherein the lower portion of the waveguide is a portion of the substrate made of a material selected from a group consisting of quartz (SiO₂), barium titanate (BaTiO₃), lithium tantalate (LiTaO₃), lithium niobate (LiNbO₃), gallium arsenide (GaAs), silicon carbide (SiC), langasite (LGS), zinc oxide (ZnO), aluminum nitride (AlN), lead zirconium titanate (PZT), and polyvinylidene fluoride (PVdF).

17. The analytic method of claim 12, wherein the consideration of temperature effects includes third order thermal expansion coefficients.

18. A machine-readable medium having a program of instructions for simulating a surface acoustic wave in a waveguide taking temperature effects into consideration, the program of instructions comprising:
program instructions for analyzing an upper portion of the waveguide including an array of electrodes with a finite element method, the analyzing including solving governing equations that consider temperature effects on materials of the waveguide; and
program instructions for analyzing a lower portion of the waveguide including a bottom of the waveguide with an analytic method, the analyzing including solving the governing equations that consider temperature effects on materials of the waveguide, wherein a traction-free condition is enforced at the bottom of the waveguide.

19. The machine-readable medium of claim 18, wherein the governing equations include Newton's equation of motion and Gauss's equation of charge conservation, and wherein displacement and electric field in the lower portion of the waveguide are approximated by a finite expansion of space harmonics, and wherein different temperatures yield different constants in the governing equations.

20. The machine-readable medium of claim 19, wherein all non-trivial roots of Christoffel equations of each space harmonic term are used and the simulating the surface acoustic wave involves finding a first four non-trivial analytic solutions to the Christoffel equation in which the imaginary part is less than zero and determining four additional solutions based on the first four solutions.
